(19) United States
(12) Patent Application Publication
(10) Pub. No.: US 2010/0100396 A1
(43) Pub. Date: Apr. 22, 2010

(54) MEDICAL DECISION-MAKING TOOL

(75) Inventors: Joel R. DAVEN, Roseburg, OR (US); Terry J. CROWDER, Monmouth, OR (US)

Correspondence Address: KOLISCH HARTWELL, P.C., 200 PACIFIC BUILDING, 520 SW YAMHILL STREET, PORTLAND, OR, 97204, US

(73) Assignee: MONITORX, LLC, Roseburg, OR (US)

(21) Appl. No.: 12/603,430

(22) Filed: Oct. 21, 2009

Related U.S. Application Data
(60) Provisional application No. 61/196,938, filed on Oct. 21, 2008.

(51) Int. Cl. G06Q 50/00; G06F 3/048

(52) U.S. Cl. 705/3; 715/808; 715/764

(57) ABSTRACT

Methods and apparatus for generating a graphical representation of a selected set of pharmacy claims data that includes information about a plurality of pharmacy claims. The methods and apparatus include or perform the steps of: (a) receiving one or more selection parameters corresponding to the selected set of pharmacy claims data; (b) accessing a data collection containing one or more sets of pharmacy claims data, including the selected set of pharmacy claims data; and (c) generating the graphical representation, which includes one or more symbols positioned along a virtual timeline, each symbol corresponding to one of the plurality of pharmacy claims, and each symbol positioned on the timeline according to a date that the corresponding pharmacy claim was made.

### CROSS-REFERENCE TO RELATED APPLICATION

This application claims priority under 35 U.S.C. §119(e) to U.S. Provisional Patent Application Ser. No. 61/196,938 entitled “Medical Decision-Making Tool,” filed Oct. 21, 2008, the complete disclosure of which is herein incorporated by reference for all purposes.

### BACKGROUND

In order to make decisions about how to treat their patients, health care providers frequently require information about their patients' past and current usage of medications, including information regarding medication adherence, narcotic usage, refill history (such as early refills), and polypharmacy.

However, health care providers do not have adequate tools for assessing or tracking a patient's past and current usage of medications. Generally, health care providers can only obtain information on patient-specific medication usage from an encounter interview with the patient or by calling a patient's pharmacy. Obtaining information about medication usage from an encounter interview with the patient is inadequate, because patient recall of medication usage is notoriously inaccurate and often over estimated. Calling a patient's pharmacy also is inadequate, because patients visit multiple pharmacies, pharmacies are constrained by privacy laws (e.g., the Health Insurance and Portability Act of 1996), and the health care provider is constrained by the lack of time created by a busy practice. Moreover, even if the health care provider is able to obtain accurate information about a patient's medication usage from an encounter interview or from calls to a patient's pharmacy or pharmacies, this information is not received in a format that is easy to read, analyze, and interpret without lengthy analysis. As a result, health care providers often do not have sufficient information to enable them to make the best decisions about how to treat their patients.

### BRIEF DESCRIPTION OF THE DRAWINGS

FIG. 1 is a block diagram showing a system for generating a graphical representation of pharmacy claims data, according to aspects of the present disclosure.

FIG. 2 is a screen shot showing a menu for receiving selection parameters, according to aspects of the present disclosure.

FIG. 3 is a screen shot showing a graphical representation of pharmacy claims data, according to aspects of the present disclosure.

FIG. 4 is a screen shot showing a tool for generating a visually readable list of information regarding various patients' usage of a particular medication.

### DETAILED DESCRIPTION

The present disclosure provides medical decision-making tools, including methods and apparatus that enable health care providers to assess and track medication usage. In one aspect, the present disclosure provides graphical representations of pharmacy claims data (i.e., data relating to one or more pharmacy claims that are made when a patient fills or attempts to fill a prescription for a medication at a pharmacy) in a format that is easy to read and analyze. Health care providers can use these graphical representations as a reference for analyzing patients' medication usage, including the patients' medication adherence, narcotic usage, medication refill history (including early refills), and polypharmacy. In another aspect, the present disclosure provides methods and apparatus for generating graphical representations of pharmacy claims data. Health care providers can use the methods and apparatus to select a patient and generate a graphical representation of the pharmacy claims data relating to that patient. In another aspect, the present disclosure provides methods and apparatus for generating visually readable lists of information regarding various patients' usage of a particular medication (i.e., population based utilization information), which can be used by health care providers, such as health care plan managers and administrators, to evaluate whether any patients are over- or under-utilizing that medication, and to make and implement decisions that improve patient-specific disease management and reduce pharmacy costs. The medical decision-making tools disclosed herein can be used by health care providers wherever and whenever needed, without having to rely upon receiving information from a patient encounter interview or from a patient's pharmacy or pharmacies, while significantly reducing the amount of time necessary to analyze the medication usage information.

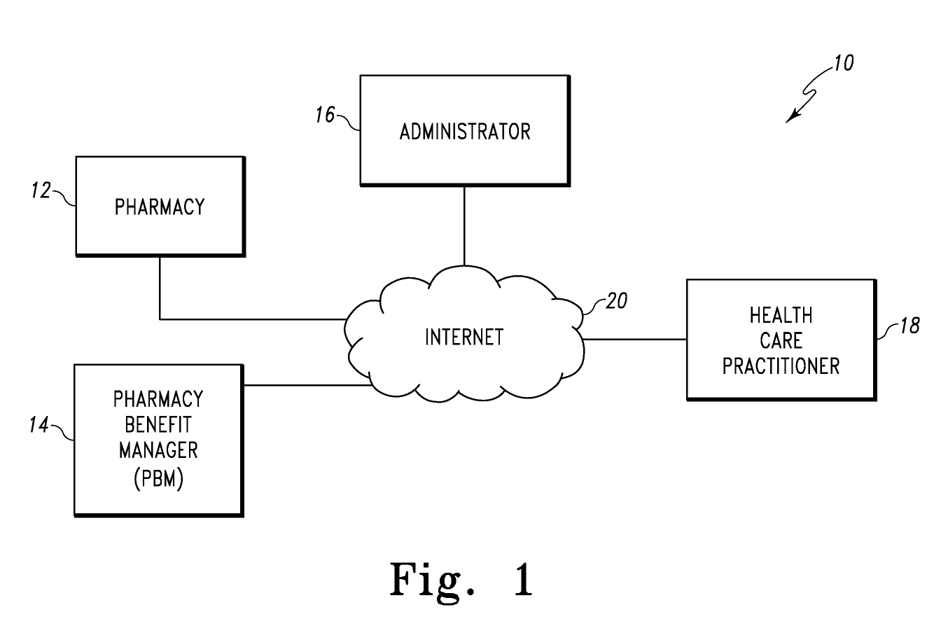

FIG. 1 is a block diagram showing a system 10 for generating a graphical representation of pharmacy claims data, according to aspects of the present disclosure. The system 10 may include one or more computers and/or computer networks associated with one or more institutions that collect, store, process, and display pharmacy claims data. For example, the system may include one or more computers and/or computer networks associated with pharmacies 12, pharmacy benefit managers 14, administrators 16, and health care practitioners 18. These computers and/or computer networks each may be networked with one another via local area networks or wide area network(s), such as the internet 20 (as shown in FIG. 1).

A pharmacy claim is made when a patient fills or attempts to fill a prescription for a medication at a pharmacy, and information about the pharmacy claim is entered into the computer(s) or computer network(s) of the pharmacy 12. The pharmacy claim is then processed by a pharmacy benefit manager (PBM), which stores information about each pharmacy claim (i.e., pharmacy claims data associated with each pharmacy claim) in a data collection, such as in a pharmacy claims database associated with the computer(s) or computer network(s) of the PBM 14. The information about each pharmacy claim may include one or more pieces of information, including but not limited to: (a) information about the identity of the patient that made the pharmacy claim by filling or attempting to fill the prescription for the medication at the pharmacy, (b) the date the pharmacy claim was made, (c) the name or other identifying information of the physician that issued the prescription, (d) the name of the medication associated with the pharmacy claim, (e) the therapeutic or pharmacological classification type of the medication associated with the pharmacy claim, (f) an indication of whether the pharmacy claim was accepted or rejected, (g) the number of units of the medication that was dispensed by the pharmacy in connection with the pharmacy claim, (h) the number of days supply of the medication that was dispensed by the pharmacy in connection with the pharmacy claim, (i) the name of the pharmacy that received the pharmacy claim, and/or (j) the contact information for the pharmacy that received the pharmacy claim.

The medical decision-making tools disclosed herein include software-based tools, such as database management tools, that use metrics, algorithms, and graphics to access and process selected pharmacy claims data that is stored in a database. These software-based medical decision-making tools may be hosted on computer(s) and/or computer network(s) associated with pharmacy benefit managers 14 and/or administrators 16, and may utilize and/or include a database of pharmacy claims data that includes information about a plurality of pharmacy claims. For example, if the medical decision-making tools are hosted on computer(s) and/or computer network(s) associated with the PBM 14, then the medical decision-making tools may be adapted to access and use the pharmacy claims data stored on the PBM's pharmacy claims database. Alternatively or additionally, if the medical decision-making tools are hosted on computer(s) and/or computer network(s) associated with either the PBM 14 or the administrator 16 of a health plan, then the medical decision-making tools may include a separate medical decision-making tools database for storing pharmacy claims data, and the medical decision-making tools may be adapted to periodically access and download current or updated pharmacy claims data (such as on an hourly, daily, or weekly basis) from the pharmacy claims database associated with the PBM to the medical decision-making tools database associated with either the PBM or the administrator, where the pharmacy claims data can be accessed and used by the medical decision-making tools.

The medical decision-making tools may be accessible for use via local area networks and/or wide area networks (such as the internet 20) by host and/or client computer(s) and/or computer network(s) associated with pharmacy benefit managers 14, administrators 16, and/or health care practitioners 18 (such as physicians or physicians' offices), or by anyone else having appropriate permissions to use the tools to access and process pharmacy claims data (e.g., via any other form of secure network, such as a password protected network available through subscription). For example, the medical decision-making tools may include a local area module that allows users of certain computers within the local area network of the host to use the tools to access and process pharmacy claims data. Alternatively or additionally, the medical decision-making tools may include an internet-based module that allows users of computers on a wide area network to use the tools stored on the host computer(s) or computer network(s) to access and process pharmacy claims data. As described in more detail below, the local area module may have capabilities that are the same as or different than the web-based module.

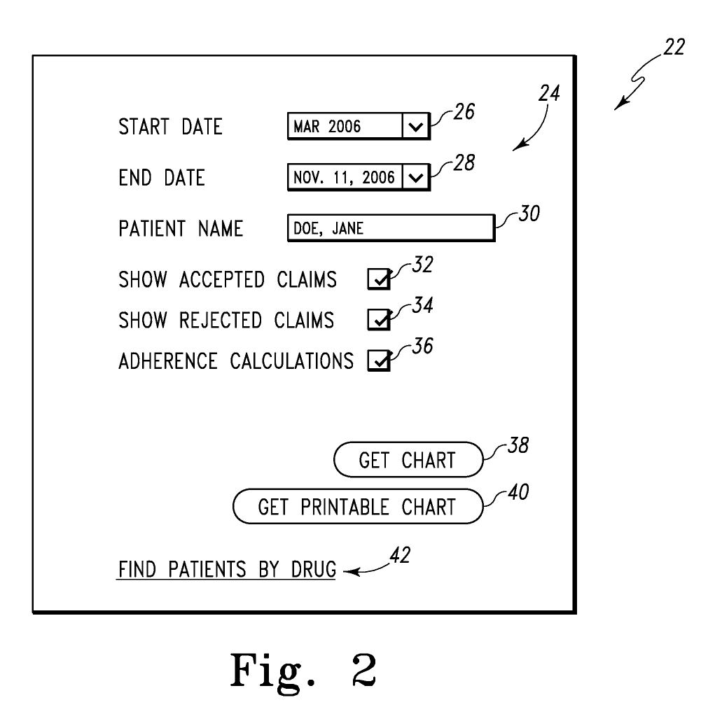

FIGS. 2-4 are screen shots showing an exemplary embodiment of the medical decision-making tools of the present disclosure. Because these tools are software-based, they include computer-executable instructions, stored on a computer-readable medium, and having instructions adapted to cause a computer to access and process pharmacy claims data in various steps. These steps generally include receiving one or more selection parameters corresponding to a selected set of pharmacy claims data; accessing a data collection (such as a database) containing one or more sets of pharmacy claims data, including the selected set of pharmacy claims data; generating data for forming a graphical or visual representation of the selected set of pharmacy claims data, and displaying the graphical or visual representation of the selected pharmacy claims data on a user interface, such as a user-interface associated with a host or client computer.

FIG. 2 is a screen shot showing an exemplary embodiment of a menu 22 for receiving selection parameters. The menu may include one or more fields 24 for receiving selection parameters, such as a start date field 26, an end date field 28, a member or patient name field 30, a show accepted claims field 32, a show rejected claims field 34, and an adherence calculations field 36. A user of the medical decision-making tools may enter or select the desired selection parameters corresponding to a set of pharmacy claims data the user wishes to access, process, and display in a graphical or visual format. For example, a user may enter or select a date range with the start date field 26 and end date field 28, and a patient name with the member or patient name field 30, in order to select a set of pharmacy claims data that includes information about pharmacy claims made only by the selected patient within the date range. A user may select the show accepted claims field 32 in order to select a set of pharmacy claims data that includes information about all accepted pharmacy claims that meet the selection criteria of the other selection parameters. A user may select the show rejected claims field 34 in order to select a set of pharmacy claims data that includes information about all rejected pharmacy claims that meet the selection criteria of the other selection parameters. Finally, and as discussed in more detail below, the user may select the adherence calculations field 36 in order to instruct the medical decision-making tools to perform and display adherence calculations corresponding to the selected set of pharmacy claims data. Some of the fields 24 (such as the adherence calculations field 36) may only be available for use by users of a local area module associated with the host, whereas some fields may be available for use by users of either a local area module or a internet-based module.

Once a user has entered the selection parameters corresponding to a selected set of pharmacy claims data that the user wishes to access, process, and display in a graphical or visual format, the user may send a request for the selected set of pharmacy claims data by selecting a get chart tool 38 and/or a get printable chart tool 40. Upon selecting one of these tools, the medical decision-making tools receives the selection parameters entered by the user using the various fields 24, accesses a data collection (such as a database associated with the host computer(s) or computer network(s)) containing one or more sets of pharmacy claims data, including the selected set of pharmacy claims data, and retrieves the selected set of pharmacy claims data. The tool then processes the selected set of pharmacy claims data to generate data for forming a graphical representation of the selected set of pharmacy claims data, and displays the graphical representation on a user-interface associated with the user.

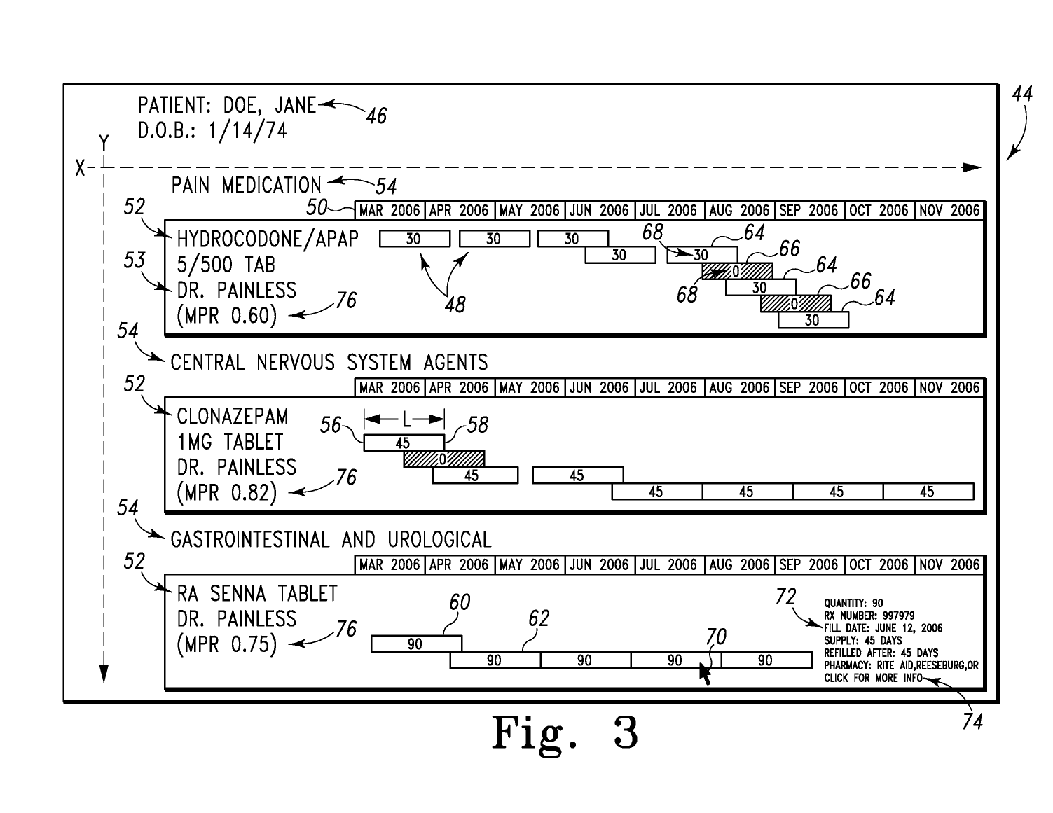

FIG. 3 is a screen shot showing an exemplary embodiment of a graphical representation 44 of a selected set of pharmacy claims data that includes information about one or more pharmacy claims. As discussed above, the information stored in the host's database about each pharmacy claim may include one or more pieces of information, including but not limited to: (a) information about the identity of the patient (such as the name, social security number, health plan member or patient number, date of birth, contact information and/or any other identifying information) that made the pharmacy claim by filling or attempting to fill the prescription for the medication at the pharmacy, (b) the date the pharmacy claim was made, (c) the name or other identifying information of the physician that issued the prescription, (d) the name of the medication associated with the pharmacy claim, (e) the therapeutic or pharmacological classification type of the medication associated with the pharmacy claim, (f) an indication of whether the pharmacy claim was accepted or rejected, (g) the number of units of the medication that was dispensed by the pharmacy in connection with the pharmacy claim, (h) the number of days supply of the medication that was dispensed by the pharmacy in connection with the pharmacy claim, (i) the name of the pharmacy that received the pharmacy claim, and/or (j) the contact information for the pharmacy that received the pharmacy claim. The graphical representation 44 may include some or all of these pieces of information for the pharmacy claims associated with the selected set of pharmacy claims data.

The graphical representation 44 may include a label 46 that provides information about the selected set of pharmacy claims data, a first axis X, a second axis Y that is normal to the first axis X, and one or more symbols 48, where each symbol corresponds to one of the one or more pharmacy claims associated with the selected set of pharmacy claims data, and has a position relative to the first axis X and second axis Y that depends on the information stored in the host's database about the corresponding pharmacy claim. The label 46 may include any desired information about the selected pharmacy claims data, including information about the selection parameters selected to generate the graphical representation. For example, as shown in FIG. 3, the label 46 may include identifying information about the patient, such as the name of the patient selected with the member or patient name field 30, the date of birth of the selected patient, or any other identifying information. Although not shown in FIG. 3, the label 46 also may include the date range selected using the start date field 26 and end date field 28, and/or may provide an indication of whether the graphical representation includes accepted claims (as selected with the show accepted claims field 32) rejected claims (as selected with the show rejected claims field 34) and adherence calculations (as selected with the adherence calculations field 36).

The first axis X may be a time-based axis, and may include axis labels 50 designating dates and/or time periods associated with the selected set of pharmacy claims data. For example, as shown in FIGS. 2 and 3, if a user selects a date range of March 2006 to Nov. 11, 2006, then the first axis X may include axis labels 50 showing a virtual timeline of the months within the selected date range.

The second axis Y may be a non-time-based axis, and may include several features or components having different functions. First, the second axis Y may include a list of the names 52 of each of the different medications that are associated with the various pharmacy claims associated with the selected set of pharmacy claims data. For example, as illustrated in FIG. 3, if the selected set of pharmacy claims data includes information about a plurality of pharmacy claims for a plurality of different medications (such as information about a plurality of pharmacy claims made for 5/500 Hydrocodone/APAP tablets, 1 mg Clonazepam tablets, and RA Senna tablets), then the second axis Y may include a list of the names 52 of each of the different medications (such as a list that includes 5/500 Hydrocodone/APAP tablets, 1 mg Clonazepam tablets, and RA Senna Tablets).

Second, each of the different medications listed along the second axis Y may be associated with the name 53 of the health care provider that prescribed that medication. Moreover, if a selected patient filled or attempted to fill prescriptions for the same medication written by more than one health care provider, then the name 52 of that medication may be listed duplicatively along the second axis Y for each health care provider. These features would enable a user of the graphical representation 44 (e.g., a health care provider) to determine the identity of other health care providers that are providing the patient with particular medications, so that the user can coordinate treatment plans with the other health care providers (e.g., to avoid toxicity), and so that the user can see if a patient has or is abusing a medication (such as a narcotic) by obtaining prescriptions from multiple health care providers.

Third, each of the different medications listed along the second axis Y may be grouped according to the therapeutic or pharmacological classification type of each of the different medications associated with the selected set of pharmacy claims data, where the names 54 of these therapeutic or pharmacological classification types may be listed along the second axis Y. For example, as illustrated in FIG. 3, if the selected set of pharmacy claims data includes information about a plurality of pharmacy claims made for medications falling under a plurality of different therapeutic or pharmacological classifications (such as pain medications, central nervous system agents, and medications for treating gastrointestinal and urological conditions), then the Y axis may include a list of names 54 of these different therapeutic or pharmacological classification types. Moreover, the name(s) 52 of each medication classified in each therapeutic or pharmacological classification type may be grouped and listed proximate the name 54 of the corresponding therapeutic or pharmacological classification type. For example, as shown in FIG. 3, the 5/500 Hydrocodone/APAP tablets are shown to be pain medications, the 1 mg Clonazepam tablets are shown to be central nervous system agents, and the RA Senna tablets are shown to be medications for the treatment of gastrointestinal and/or urological conditions. Although not shown in FIG. 3, if the selected set of pharmacy claims data includes information about pharmacy claims for multiple medications falling under a particular therapeutic or pharmacological classification type, then the names 52 of these medications may be grouped together and listed below the name 54 of the corresponding therapeutic or pharmacological classification type.

Finally, and for reasons discussed below, the portion of the Y axis associated with each medication name 52 listed along the Y axis, may be wider or narrower depending on whether and to what extent the symbols associated with that medication form a cascading pattern on the graphical representation 44, such as the cascading symbol patterns shown in FIG. 3.

Each symbol 48 corresponds to one of the one or more pharmacy claims associated with the selected set of pharmacy claims data, and has a size and a position relative to the first axis X and second axis Y that depends on the information stored in the host's database about the corresponding pharmacy claim. The position of each symbol 48 relative to the first axis X may depend on the date the corresponding pharmacy claim was made and the size of each symbol may depend on the number of day's supply of the medication that was dispensed by the pharmacy in connection with the corresponding pharmacy claim. For example, as shown in FIG. 3, each symbol may include a start portion 56, an end portion 58 and a length L extending between the start and end portions. The start portion 56 may be positioned relative to the first axis X according to the date the corresponding pharmacy claim was made. The end portion 58 may be positioned relative to the first axis X according to a theoretical stop date of the corresponding pharmacy claim, where the theoretical stop date may be determined by adding (a) the number of days supply of the medication that was dispensed by the pharmacy in connection with the corresponding pharmacy claim to (b) the date the corresponding pharmacy claim was made. Because the positions of each symbol's start and stop portions relative to the first axis X may depend on the date the corresponding pharmacy claim was made, the entire symbol may be positioned on the time-based axis according to the date the corresponding pharmacy claims was made. Moreover, because the position of each symbol's stop portion relative to the first axis X may depend on the number of days supply of the medication that was dispensed by the pharmacy in connection with the corresponding pharmacy claim, each symbol's length L also may depend on and may be proportional to the number of days supply of the medication dispensed by the pharmacy in connection with the corresponding pharmacy claim.

The position of each symbol 48 relative to the second axis Y may depend on one or more of (a) the name of the medication associated with the corresponding pharmacy claim, and (b) the therapeutic or pharmacological classification type of the medication associated with the corresponding pharmacy claim. For example, as shown in FIG. 3, the position of each symbol relative to the second axis Y may be substantially adjacent to the name 52 of the medication associated with the corresponding pharmacy claim and listed along the second axis Y. Moreover, because the name(s) 52 of each medication listed along the second axis Y may be grouped and listed proximate the name 54 of the corresponding therapeutic or pharmacological classification type, the position of each symbol relative to the second axis Y also may depend on the therapeutic or pharmacological medication type associated with the corresponding pharmacy claim.

The position of each symbol 48 relative to the second axis Y also may depend on the positions of other symbols relative to the first axis X and second axis Y. For example, as shown in FIG. 3, the graphical representation 44 may include a first symbol 60 (corresponding to a first pharmacy claim made for a particular medication) that overlaps on the first axis X with a second symbol 62 (corresponding to a second pharmacy claim made for the same medication), such as when the start portion of the second symbol 62 is positioned between the start and stop portions of the first symbol 60. This may occur when the selected set of pharmacy claims data includes information about a second pharmacy claim (e.g., the second pharmacy claim corresponding to second symbol 62) that is made on a date that is earlier than the theoretical stop date of a first pharmacy claim (e.g., the first pharmacy claim corresponding to first symbol 60). When this occurs, the first symbol 60 and second symbol 62 may be displaced from one another on the second axis Y (such as by positioning the second symbol directly below the first symbol), so that the first and second symbols do not overlap on the second axis Y. Moreover, the portion of the second axis Y associated with each of the listed medication names 52 may be wider or narrower depending on the frequency that symbols associated with that medication overlap with one another on the first axis X and are thus displaced relative to one another on the second axis Y.

When a plurality of symbols associated with a particular medication are plotted relative to the first axis X and the second axis Y in the manner described above, the symbols associated with that medication may be separated by gaps, or may be directly adjacent to or overlapping with one another on the first axis X, and may thereby form a cascading pattern on the graphical representation 44. This cascading pattern clearly shows when prescriptions for medications were filled and should have been filled, thereby enabling a user to more readily observe trends in medication usage by suggesting when medication usage likely started or stopped, and also by suggesting the rate at which medications are being taken. Moreover, if medications are routinely filled to early by a patient, then this will become readily apparent by the cascading effect, and may have therapeutic implications regarding medication overutilization. A health care provider can then use this information to counsel the patient or adjust prescription frequency.

In some embodiments, symbols corresponding to accepted pharmacy claims may have a different color(s) or shape(s) than symbols corresponding to accepted pharmacy claims. For example, as shown in FIG. 3, symbols 64 (which are depicted without crosshatching to represent symbols having a first color) correspond to accepted pharmacy claims, and symbols 66 (which are depicted with cross hatching to represent symbols having a second color) correspond to rejected pharmacy claims. The medical decision-making tools may be adapted to only include symbols corresponding to accepted claims on the graphical representation 44 if the user selected the show accepted claims field 32 on the menu 22 for receiving selection parameters (See FIG. 2). Likewise, the medical decision-making tools may be adapted to only include symbols corresponding to rejected claims on the graphical representation 44 if the user selected the show rejected claims field 34 on the menu 22 for receiving selection parameters (See FIG. 2). By presenting symbols corresponding to accepted and rejected claims in different color(s) and/or shape(s) on the same graphical representation 44, a user of the graphical representation can easily see when a patient's attempts to fill a prescription have been rejected, such as when a patient attempted to fill a prescription for a medication that is not covered by the patient's health plan, or when a patient attempted to refill a prescription earlier than the patient's health plan allows (which may indicate an abuse of a medication).

In some embodiments, each symbol 48 associated with the graphical representation 44 may include an associated numerical indicator 68 corresponding to the number of units of a medication that was dispensed by a pharmacy in association with the corresponding pharmacy claim. For example, as shown in FIG. 3, symbols corresponding to accepted pharmacy claims (such as symbols 64) may include a numerical indicator, positioned between the start and stop portions of the symbol, that shows the number of units of the medication that was dispensed by the pharmacy in association with the corresponding pharmacy claim. In contrast, symbols corresponding to rejected pharmacy claims (such as symbols 66) may have the numerical indicator “0” positioned between the start and stop portions of the symbol, or may have no numerical indicator at all.

In some embodiments, the graphical representation may include a “mouse over” function. Specifically, when a user moves a mouse cursor 70 over a particular symbol, the medical decision-making tools may be adapted to cause the user's computer to display an associated pop-up window or display 72 on the user's user-interface. The pop-up window or display associated with each symbol may include at least one of the one or more pieces of information about the pharmacy claim corresponding to that symbol. For example, as shown in FIG. 3, the pop-up window or display may include any desired information about the corresponding pharmacy claim including but not limited to: the number of units of the medication that was dispensed in connection with the corresponding pharmacy claim (e.g., the “quantity”); the Rx number of the medication, the date the corresponding pharmacy claim was made (e.g., the “fill date”); the number of days supply of the medication that was dispensed (e.g., the “supply”); the date that the next pharmacy claim was made for the same medication (i.e., the “refilled after” field); the name of the pharmacy that filled the prescription (i.e., the “pharmacy”), and/or the contact information for the pharmacy that filled the prescription. The pop-up window or display also may include an additional “click here for info” tab 74 that the user may click on to provide a more expansive list of information about the corresponding pharmacy claim.

In some embodiments, the medical decision-making tools may be adapted to perform adherence calculations. Medication adherence is composed of medication compliance (how well a patient follows a health care practitioner's orders to take a medication within a time frame) and persistence (how long a patient remains on therapy). The adherence calculations of the medical decision-making tools disclosed herein may be adapted to provide a numerical value (i.e., the Medication Possession Ratio) that is indicative of a patient's medication compliance. The Medication Possession Ratio is defined as the number of days for which a medication is supplied divided by the number of days in an observation period (i.e., the number of days for which a health care practitioner recommends that a patient take the medication). Using the information about each pharmacy claim associated with the selected set of pharmacy claims data, the medical decision-making tools may be adapted to calculate the Medication Possession Ratio of a selected patient for medications they have been prescribed. The medical decision-making tools may be adapted to perform this calculation when a user selects the adherence calculations field 36 on the menu 22 for receiving selection parameters (See FIG. 2). A textual display 76 of the calculated Medication Possession Ratio for a particular medication then may be displayed on the graphical representation 44, such as proximate to the name 52 of each medication listed along the second axis Y. This feature of the medical decision-making tools enables a user to evaluate a patient's medication compliance for a particular medication.

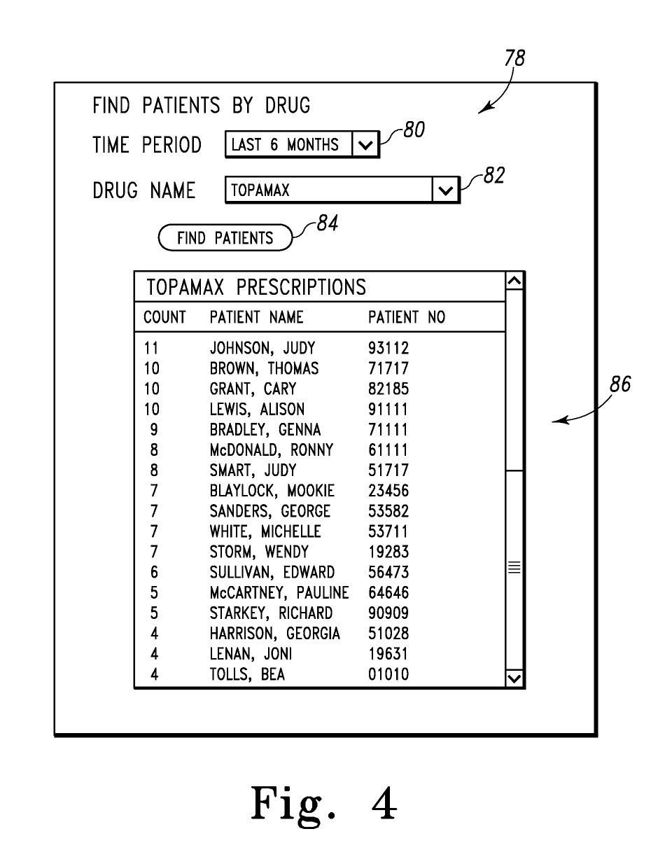

In some embodiments, the medical decision-making tools may be adapted to be used to select a set of pharmacy claims data corresponding to the pharmacy claims made by a plurality of patients for a particular medication, and to display information about those pharmacy claims in a visual format (i.e., population based utilization information). As shown in FIG. 2, the medical decision-making tools may include a “find patient by drug” tool 42, such as by providing a link on menu 22 to the tool. This tool may only be available for use by users of a local area module associated with the host, and may not be available for use by users of an internet-based module. By selecting the link, the medical decision-making tool may present a new selection menu 78 for receiving selection parameters. The menu 78 may include one or more selection fields, including a time period field 80 and a drug name field 82. A user may use these fields to enter selection parameters corresponding to the desired time period and/or the name of a selected medication. The user may then select a “find patients” tool 84, whereby the medical decision-making tool may be adapted to receive the selection parameters, access the host's database containing pharmacy claims data, and retrieve from the database information about pharmacy claims made only for the selected medication. This information may include the names of patients that filled prescriptions for the selected medication and the number of times each patient filled prescriptions for the selected medication. The medical decision-making tool may then generate data that is adapted to form a visually readable list 86 of the names of the patients that filled prescriptions for the selected medication. This list also may include any desired additional information about the patient, such as the patient or member number, the patient's contact information, etc. As shown in FIG. 4, the list of the patient's names may be presented in an ascending or descending order relative to the number of times each patient filled prescriptions for the selected medication. This list can be used to gather information about patients who are potentially over or under utilizing medications. And can be used by health plan medical and administrative personnel to improve patient-specific disease management, and to help reduce pharmacy costs.

The medical decision-making tools disclosed herein provide numerous benefits to health care providers. By making information about pharmacy claims accessible at anytime and anywhere, and by providing graphical and visual representations of pharmacy claims data that are easy to read and analyze, the medical decision-making tools enable health care providers to manage diseases while reducing the potential for: medication toxicity; therapeutic duplication; drug-drug interactions; medication overuse, under-use or abuse. The graphical representation of pharmacy claims data also shows any seasonal or other medication-related patterns or trends.

It is believed that this disclosure encompasses multiple distinct inventions with independent utility. While each of these inventions has been described in its best mode, numerous variations are contemplated. All novel and non-obvious combinations and subcombinations of the described and/or illustrated elements, features, functions, and properties should be recognized as being included within the scope of this disclosure. Applicant reserves the right to claim one or more of the inventions in any application related to this disclosure. Where the disclosure or claims recite “a,” “a first,” or “another” element, or the equivalent thereof, they should be interpreted to include one or more such elements, neither requiring nor excluding two or more such elements.

What is claimed is:

1. A method of generating a graphical representation of a selected set of pharmacy claims data that includes information about a plurality of pharmacy claims, comprising:
receiving one or more selection parameters corresponding to the selected set of pharmacy claims data;
accessing a data collection containing one or more sets of pharmacy claims data, including the selected set of pharmacy claims data; and
generating the graphical representation;
wherein the graphical representation includes one or more symbols positioned along a time-based axis, each symbol corresponding to one of the plurality of pharmacy claims, and each symbol positioned on the time-based axis according to a date that the corresponding pharmacy claim was made.

2. The method of claim 1, wherein the one or more selection parameters include the name of a selected patient and a date range, and the selected set of pharmacy claims data includes information about pharmacy claims made only by the selected patient within the date range.

3. The method of claim 2, further comprising the step of calculating a Medication Possession Ratio of the selected patient for a medication, and the graphical representation of the selected set of pharmacy claims data includes a textual display of the Medication Possession Ratio.

4. The method of claim 1, wherein the information about each pharmacy claim includes one or more pieces of information selected from the group consisting of: (a) a name of a patient that made the pharmacy claim by filling or attempting to fill a prescription for a medication at a pharmacy, (b) the date that the pharmacy claim was made, (c) a name or other identifying information of a physician that issued the prescription, (d) a name of the medication associated with the pharmacy claim, (e) a therapeutic or pharmacological classification type of the medication associated with the pharmacy claim, (f) an indication of whether the pharmacy claim was accepted or rejected, (g) a number of units of the medication that was dispensed by the pharmacy in connection with the pharmacy claim, (h) a number of days supply of the medication that was dispensed by the pharmacy in connection with the pharmacy claim, (i) a name of the pharmacy that received the pharmacy claim, and (j) contact information for the pharmacy that received the pharmacy claim.

5. The method of claim 4, wherein the graphical representation includes a second axis that is normal to the time-based axis, and wherein the position of each symbol on the graphical representation relative to the second axis is dependent on either or both of (a) the name of the medication associated with the corresponding pharmacy claim, and (b) the therapeutic or pharmacological classification type of the medication associated with the corresponding pharmacy claim.

6. The method of claim 5, wherein the plurality of pharmacy claims includes pharmacy claims for a plurality of different medications, and the second axis includes a list of the names of each of the different medications associated with the plurality of pharmacy claims, and wherein each symbol is positioned relative to the second axis at a position that is substantially adjacent to the name of the medication associated with the corresponding pharmacy claim.

7. The method of claim 6, wherein each of the plurality of different medications listed along the second axis is grouped according to the therapeutic or pharmacological classification type of each of the different medications.

8. The method of claim 4, wherein each symbol includes an associated numerical indicator corresponding to the number of units of the medication that was dispensed by the pharmacy in association with the corresponding pharmacy claim.

9. The method of claim 4, wherein each symbol includes:
a start portion that is positioned relative to the time-based axis according to the date the corresponding pharmacy claim was made;
a stop portion that is positioned relative to the time-based axis according to a theoretical stop date of the corresponding pharmacy claim, the theoretical stop date being determined by adding (a) the number of days supply of the medication that was dispensed by the pharmacy in connection with the corresponding pharmacy claim to (b) the date the corresponding pharmacy claim was made; and
a length extending between the start portion and the stop portion that depends on the number of day's supply of the medication that was dispensed by the pharmacy in connection with the corresponding pharmacy claim.

10. The method of claim 9, wherein the graphical representation includes:
a second axis that is normal to the time-based axis;
a first symbol having a first start portion and a first stop portion; and
a second symbol having a second start portion that is positioned between the first start portion and first stop portion on the time-based axis;
wherein the first and second symbols have different positions on the second axis such that the first symbol and second symbols do not overlap relative to the second axis.

11. The method of claim 4, wherein moving a mouse cursor over each symbol causes the computer to display an associated pop-up on the user-interface, the pop-up associated with each symbol including at least one of the one or more pieces of information for the corresponding pharmacy claim.

12. A computer-readable medium having computer-executable instructions adapted to cause a computer to perform steps comprising:
receiving one or more selection parameters corresponding to a selected set of pharmacy claims data that includes information about a plurality of pharmacy claims;
accessing a database containing a plurality of sets of pharmacy claims data, including the selected set of pharmacy claims data; and
generating data for forming a graphical representation of the selected set of pharmacy claims data, the graphical representation including one or more symbols positioned along a time-based axis, each symbol corresponding to one of the plurality of pharmacy claims, and each symbol positioned on the time-based axis according to a date that the corresponding pharmacy claim was made.

13. The computer-readable medium of claim 12, wherein the one or more selection parameters include the name of a selected patient and a date range, and the selected set of pharmacy claims data includes information about pharmacy claims made only by the selected patient within the date range.

14. The computer-readable medium of claim 13, wherein the computer-executable instructions are further adapted to cause the computer to perform the step of calculating a Medication Possession Ratio of the selected patient for a medication, and the graphical representation of the selected set of pharmacy claims data includes a textual display of the Medication Possession Ratio.

15. The computer-readable medium of claim 12 wherein the information about each pharmacy claim includes one or more pieces of information selected from the group consisting of: (a) a name of a patient that made the pharmacy claim by filling or attempting to fill a prescription for a medication at a pharmacy, (b) the date that the pharmacy claim was made, (c) a name of the medication associated with the pharmacy claim, (d) a therapeutic or pharmacological classification type of the medication associated with the pharmacy claim, (e) a number of units of the medication that was dispensed by the pharmacy in connection with the pharmacy claim, (f) a number of days supply of the medication that was dispensed by the pharmacy in connection with the pharmacy claim, (g) a name of the pharmacy that received the pharmacy claim, and (h) contact information for the pharmacy that received the pharmacy claim.

16. The computer-readable medium of claim 15, wherein the graphical representation includes a second axis that is normal to the time-based axis, and wherein the position of each symbol on the graphical representation relative to the second axis is dependent on either or both of (a) the name of the medication associated with the corresponding pharmacy claim, and (b) the therapeutic or pharmacological classification type of the medication associated with the corresponding pharmacy claim.

17. The computer-readable medium of claim 16, wherein the plurality of pharmacy claims includes pharmacy claims for a plurality of different medications, and the second axis includes a list of the names of each of the different medications associated with the plurality of pharmacy claims, and wherein each symbol is positioned relative to the second axis at a position that is substantially adjacent to the name of the medication associated with the corresponding pharmacy claim.

18. The computer-readable medium of claim 17, each of the plurality of different medications listed along the second axis is grouped according to the therapeutic or pharmacological classification type of each of the different medications.

19. The computer-readable medium of claim 15, wherein each symbol includes an associated numerical indicator corresponding to the number of units of the medication that was dispensed by the pharmacy in association with the corresponding pharmacy claim.

20. The computer-readable medium of claim 15, wherein each symbol includes:
a start portion that is positioned relative to the time-based axis according to the date the corresponding pharmacy claim was made;
a stop portion that is positioned relative to the time-based axis according to a theoretical stop date of the corresponding pharmacy claim, the theoretical stop date being determined by adding (a) the number of days supply of the medication that was dispensed by the pharmacy in connection with the corresponding pharmacy claim to (b) the date the corresponding pharmacy claim was made; and
a length extending between the start portion and the stop portion that depends on the number of day's supply of the medication that was dispensed by the pharmacy in connection with the corresponding pharmacy claim.

21. The computer-readable medium of claim 20, wherein the graphical representation includes:
a second axis that is normal to the time-based axis;
a first symbol having a first start portion and a first stop portion; and
a second symbol having a second start portion that is positioned between the first start portion and first stop portion on the time-based axis;
wherein the first and second symbols have different positions on the second axis such that the first symbol and second symbols do not overlap relative to the second axis.

22. The computer-readable medium of claim 15, wherein moving a mouse cursor over each symbol causes the computer to display an associated pop-up on the user-interface, the pop-up associated with each symbol including at least one of the one or more pieces of information for the corresponding pharmacy claim.

23. A graphical representation of a selected set of pharmacy claims data that includes information about a plurality of pharmacy claims, the graphical representation comprising:
a time-based axis;
a second axis that is normal to the time-based axis;
a plurality of symbols, each corresponding to one of the plurality of pharmacy claims and each positioned relative to the time-based axis according to a date that the corresponding pharmacy claim was made;
wherein a pair of symbols that overlap each other on the time-based axis have different positions relative to each other on the second axis so that the pair of symbols do not overlap each other on the second axis.

24. The graphical representation of claim 23, wherein the plurality of symbols form a substantially cascading pattern on the graphical representation.

25. The graphical representation of claim 23, wherein each symbol includes a start portion positioned on the time-based axis according to a claim date of the corresponding pharmacy claim, a stop portion positioned on the time-based axis according to a theoretical stop date of the corresponding pharmacy claim, and a length extending between the claim date and the theoretical stop date.

26. The graphical representation of claim 23, wherein each symbol includes an associated numerical indicator corresponding to the number of units of a medication that was dispensed by a pharmacy in association with the corresponding pharmacy claim.

27. A computer-readable medium having computer-executable instructions adapted to cause a computer to perform steps comprising:
receiving a selection parameter corresponding to the name of a selected medication;
accessing a database containing pharmacy claims data;
retrieving from the database information about pharmacy claims made only for the selected medication, including names of patients that filled prescriptions for the selected medication and a number of times each patient filled prescriptions for the selected medication; and
generating data that is adapted to form a visually readable list of the names of the patients that filled prescriptions for the selected medication, wherein the list of the names is presented in an ascending or descending order relative to the number of times each patient filled prescriptions for the selected medication.
